(19) United States
(12) Patent Application Publication
(10) Pub. No.: US 2025/0308782 A1
(43) Pub. Date: Oct. 2, 2025

(54) ELECTRONIC DEVICE

(71) Applicant: TDK Corporation, Tokyo (JP)

(72) Inventors: Ryota NAMIKI, Tokyo (JP); Toshihiro IGUCHI, Tokyo (JP); Kenya TAMAKI, Tokyo (JP); Kengo AIZAWA, Tokyo (JP); Naoki HAYAKAWA, Tokyo (JP)

(73) Assignee: TDK Corporation, Tokyo (JP)

(21) Appl. No.: 19/046,735

(22) Filed: Feb. 6, 2025

(30) Foreign Application Priority Data
Mar. 27, 2024 (JP) 2024-052255

(51) Int. Cl. H01G 4/12; H01G 4/008; H01G 4/012; H01G 4/30

(52) U.S. Cl. CPC H01G 4/1227; H01G 4/008; H01G 4/012; H01G 4/30

(57) ABSTRACT

An electronic device includes an element body including a ceramic layer and an internal electrode layer being laminated. The ceramic layer contains a perovskite-type compound having a main component represented by a formula ABO₃. The perovskite-type compound includes a compound representable by a composition formula (Ca₁₋ₓSrₓ)ₘ(Zr_{1-y-z}Ti_{y}Hf_{z})O₃, where m ranges from 0.9 to 1.1, x satisfies 0≤x≤1, and y and z satisfy 0.80≤1-y-z≤1.0. The element body includes segregates. The segregates contain Ca and/or Sr, Mn, Si, Ni, and O.

The present application claims a priority to Japanese patent application No. 2024-052255 filed on Mar. 27, 2024, which is incorporated herein by reference in its entirety.

### TECHNICAL FIELD

The present invention relates to an electronic device including a ceramic layer and an internal electrode layer.

### BACKGROUND

Known is a multilayer ceramic electronic device in which ceramic layers composed of a dielectric composition and internal electrode layers are alternately laminated. The ceramic layers and the internal electrode layers of this multilayer ceramic electronic device have differences in characteristics, such as shrinkage factor and linear thermal expansion coefficient. Thus, due to these differences in characteristics, structural defects (e.g., cracks) readily occur at interfaces between the ceramic layers and the internal electrode layers; and this tendency is particularly noticeable in a high-temperature and high-humidity environment.

In this regard, for example, Patent Document 1 (JP Patent Application Laid Open No. 2014-123698) discloses a method of reducing the number of cracks after firing by forming a secondary phase material at interfaces between internal electrodes and dielectric layers; however, research in terms of a high-temperature and high-humidity environment has not been conducted.

### SUMMARY

The present invention has been achieved in view of such circumstances. It is an object of the invention to provide an electronic device capable of having fewer cracks in a high-temperature and high-humidity environment.

To achieve the above object, an electronic device according to the present invention is an electronic device including an element body including a ceramic layer and an internal electrode layer being laminated,
wherein
the ceramic layer contains a perovskite-type compound having a main component represented by a formula ABO₃;
the perovskite-type compound includes a compound representable by a composition formula (Ca₁₋ₓSrₓ)ₘ(Zr_{1-y-z}Ti_{y}Hf_{z})O₃, where
m ranges from 0.9 to 1.1,

$$\begin{matrix}x statisfies 0 \leq x \leq 1 , and \\ y and z satisfy 0.8 \leq 1 - y - z \leq 1. ;\end{matrix}$$

the element body includes segregates; and
the segregates contain Ca and/or Sr, Mn, Si, Ni, and O.

Because the element body of the electronic device of the present invention includes the predetermined segregates, cracks can be prevented or reduced in a high-temperature and high-humidity environment.

The segregates may contain Al.

Preferably, the segregates are present at an electrode discontinuous portion of the internal electrode layer. Preferably, the segregates are in contact with a lamination interface between the ceramic layer and the internal electrode layer. That is, preferably, the segregates included in the element body include a segregate present at the electrode discontinuous portion of the internal electrode layer and/or a segregate in contact with the lamination interface between the ceramic layer and the internal electrode layer.

This can further prevent or reduce cracks in a high-temperature and high-humidity environment.

Preferably, a ratio {(Ca+Sr)/(Zr+Ti)} of a total atomic weight of Ca and Sr to a total atomic weight of Zr and Ti in the segregates is 1.5 to 8.0.

This can further prevent or reduce cracks in a high-temperature and high-humidity environment.

Preferably, out of a total of 100 parts by mol Hf, Ni, Mn, Ti, Si, Al, Ca, Zr, and Sr in terms of their oxides in the segregates, the total of Ca and Sr in terms of their oxides in the segregates accounts for 25 parts by mol or more and less than 60 parts by mol.

Preferably, a ratio {Mn/(Mn+Si)} of an atomic weight of Mn to a total atomic weight of Mn and Si in the segregates is 0.02 or more and less than 0.50.

This can further prevent or reduce cracks in a high-temperature and high-humidity environment.

Preferably, a ratio {Ni/(Ni+Si)} of an atomic weight of Ni to a total atomic weight of Ni and Si in the segregates is 0.02 or more and less than 0.6.

This can further prevent or reduce cracks in a high-temperature and high-humidity environment.

Preferably, an average number of the segregates per unit length of the internal electrode layer is 0.05 per μm or more and less than 0.5 per μm.

This can further prevent or reduce cracks in a high-temperature and high-humidity environment.

Preferably, the segregates have an average grain size of 0.1 μm to 15 μm.

This can further prevent or reduce cracks in a high-temperature and high-humidity environment.

Preferably, a main component of a conductive material included in the internal electrode layer includes Ni and/or a Ni based alloy.

This can further prevent or reduce cracks in a high-temperature and high-humidity environment.

Preferably, a main component of the ceramic layer includes Ca, Sr, Zr, and Ti.

This can further prevent or reduce cracks in a high-temperature and high-humidity environment.

### BRIEF DESCRIPTION OF THE DRAWING(S)

FIG. 1A is a sectional view of a multilayer ceramic capacitor according to one embodiment of the present invention.

FIG. 1B is a sectional view of the multilayer ceramic capacitor along a line IB-IB shown in FIG. 1A.

FIG. 2 is an enlarged sectional view of a main part of FIG. 1A.

### DETAILED DESCRIPTION

Hereinafter, the present invention is described in detail with reference to an embodiment illustrated in the drawings.

### First Embodiment

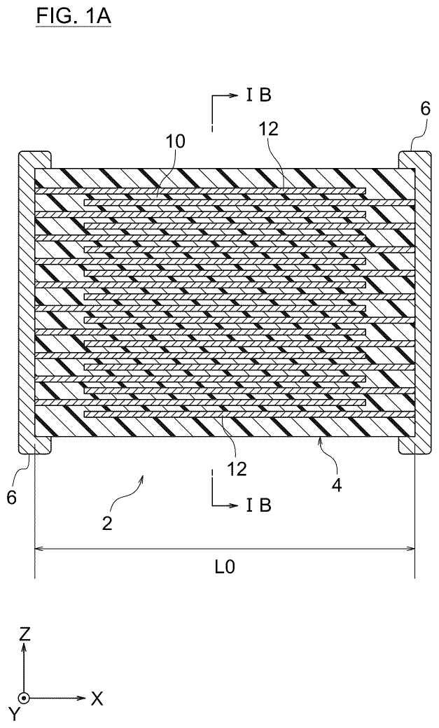

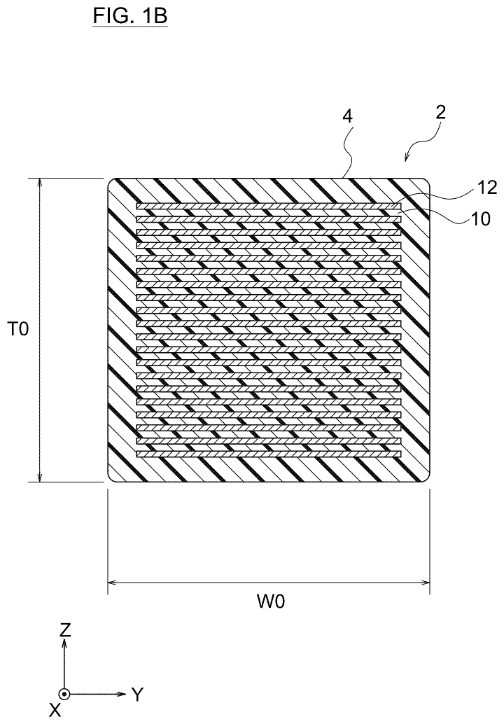

In the present embodiment, a multilayer ceramic capacitor 2 shown in FIGS. 1A and 1B is described as an example electronic device according to the present invention. The multilayer ceramic capacitor 2 includes an element body 4 and a pair of external electrodes 6 formed on outer surfaces of the element body 4.

The element body 4 shown in FIGS. 1A and 1B normally has a substantially rectangular parallelepiped shape. The element body 4 may have any other shape, such as an elliptic cylindrical shape, a cylindrical shape, or a prismatic shape. The element body 4 may have any external dimensions. For example, the element body 4 can have a length L0 of 0.4 mm to 5.7 mm in the X-axis direction, a width W0 of 0.2 mm to 5.0 mm in the Y-axis direction, and a height T0 of 0.2 mm to 3.0 mm in the Z-axis direction.

In the present embodiment, the X-axis, the Y-axis, and the Z-axis are perpendicular to each other.

The element body 4 includes ceramic layers 10 (dielectric layers 10) and internal electrode layers 12 substantially parallel to a plane containing the X-axis and the Y-axis. Inside the element body 4, the ceramic layers 10 and the internal electrode layers 12 are alternately laminated along the Z-axis direction. In this context, “substantially parallel” means that the ceramic layers 10 and the internal electrode layers 12 are mostly parallel to the plane but may partly be slightly nonparallel. The ceramic layers 10 and the internal electrode layers 12 may be slightly uneven or inclined.

The ceramic layers 10 contain a main component preferably including Ca and/or Sr and Zr or more preferably including a perovskite-type compound represented by a formula ABO₃. The main component of the ceramic layers 10 means a component, composed of the main component's constituent elements, constituting a total of 80 parts by mol or more out of a total of 100 parts by mol of all constituent elements of the ceramic layers 10. In the present embodiment, the A-site of the perovskite-type compound preferably includes at least Ca and Sr; or the perovskite-type compound is more preferably a compound (hereinafter referred to as “CSZT based compound”) that can be represented by a composition formula (Ca₁₋ₓSrₓ)ₘ(Zr_{1-y-z}Ti_{y}Hf_{z})O₃. In the composition formula, x, y, z, and m are elemental ratios; and each elemental ratio is not limited and can be determined within a known range.

For example, m represents the elemental ratio of the A-site to the B-site and can normally range from 0.9 to 1.1. Also, x represents the elemental ratio of Sr in the A-site and can satisfy 0≤x≤1. That is, the ratio of Ca to Sr is determined freely; and it may be that only either of them is contained.

Also, y represents the elemental ratio of Ti in the B-site, and z represents the elemental ratio of Hf in the B-site. That is, 1-y-z represents the elemental ratio of Zr in the B-site. In the present embodiment, 0.80≤1-y-z≤1.0 is preferably satisfied. In a situation where the elemental ratio of Zr is within the above range, high-temperature load life at a high voltage is improved, and the crack occurrence rate can further be reduced.

The elemental ratio of oxygen (O) in the above composition formula may slightly deviate from the stoichiometric composition.

Other than the above main component, the ceramic layers 10 may also contain subcomponents. Examples of subcomponents include a Mn compound, a Si compound, an Al compound, a Mg compound, a Ni compound, a Li compound, and a B compound. There is no limit to the type, combination, or content of the subcomponents.

The ceramic layers 10 include main phase grains composed of an oxide that is composed of the CSZT based compound and has a perovskite-type crystal structure and a grain boundary. The grain boundary may include segregates 14 having a composition different from that of the main phase grains. The above subcomponents of the ceramic layers 10 may be contained in the main phase grains by being solid-dissolved therein, may be contained in the grain boundary, or may be contained as the segregates 14.

The ceramic layers 10 may have any average thickness Td (interlayer thickness) per layer. For example, the average thickness can be 40 μm or less or is preferably 20 μm or less. The number of the ceramic layers 10 is determined according to desired characteristics and is not limited. The number of the ceramic layers 10 can be, for example, 20 or more or preferably 50 or more.

The internal electrode layers 12 are laminated between the ceramic layers 10. The number of the internal electrode layers 12 is determined according to the number of the ceramic layers 10. The internal electrode layers 12 may have any average thickness Te per layer. The average thickness is preferably, for example, 3.0 μm or less.

The internal electrode layers 12 are laminated so that their ends are exposed alternately to two end surfaces of the element body 4 facing each other in the X-axis direction. The external electrodes 6 are formed on the respective end surfaces of the element body 4 and are electrically connected to the exposed ends of the alternately arranged internal electrode layers 12. The internal electrode layers 12 and the external electrodes 6 formed in such a manner constitute a capacitor circuit.

Note that, as shown in FIGS. 1A and 1B, the internal electrode layers 12 are present not only along the X-axis direction but also along the Y-axis direction. Therefore, even if the internal electrode layers 12 look discontinuous along the X-axis in a sectional view parallel to a Z-X plane of the multilayer ceramic capacitor 2, the internal electrode layers 12 are in fact electrically continuous through their portions present along the Y-axis direction. Such portions where the internal electrode layers 12 look discontinuous in a section parallel to the lamination direction are hereinafter referred to as electrode discontinuous portions 12a.

The existence ratio of the electrode discontinuous portions 12a can be determined from the coverage ratio of the internal electrode layers. The coverage ratio of the internal electrode layers is, in a predetermined field of view of a section (Y-Z plane or Z-X plane) parallel to the lamination direction (Z-axis direction) of the element body 4 during observation of one ceramic layer 10 and one internal electrode layer 12 in pairs in contact with each other, the ratio of the total length of the internal electrode layer 12 along a lamination interface 11 to the total length of the ceramic layer 10 along the lamination interface 11. The length of the predetermined field of view in the lamination direction is any length in which the ceramic layer 10 and the internal electrode layer 12 in pairs in contact with each other can be seen. The length of the predetermined field of view in a direction perpendicular to the lamination direction is about 10 μm to about 500 μm. Observation is carried out in preferably about five fields of view satisfying the above conditions to calculate an average coverage ratio of the internal electrode layers.

In the present embodiment, the coverage ratio of the internal electrode layers is preferably 85% or more and 99% or less. As described later, because the segregates 14 are preferably present at the electrode discontinuous portions 12a, preferred is that the electrode discontinuous portions 12a are present as appropriate while the internal electrode layers 12 demonstrate their function. Thus, the coverage ratio of the internal electrode layers is preferably within the above range or is more preferably 90% or more and 98% or less.

The average number of the electrode discontinuous portions 12a per unit length of the lamination interface 11 is preferably 0.01 per μm or more and 1.5 per μm or less. As described later, because the segregates 14 are preferably present at the electrode discontinuous portions 12a, preferred is that the electrode discontinuous portions 12a are present at appropriate frequency while the internal electrode layers 12 demonstrate their function. Thus, the average number of the electrode discontinuous portions 12a per unit length of the lamination interface 11 is preferably within the above range or is more preferably 0.04 per μm or more and 1.5 per μm or less.

Note that the number of the electrode discontinuous portions 12a per unit length of the lamination interface 11 can be determined in the above predetermined fields of view for calculating the coverage ratio of the internal electrode layers. Observation is carried out in preferably about five fields of view satisfying the above conditions to calculate the average number of the electrode discontinuous portions 12a per unit length of the lamination interface 11.

As described above, the internal electrode layers 12 as a part of the capacitor circuit serve a function of applying voltages to the ceramic layers 10. Thus, materials of the internal electrode layers 12 include a conductive material. Specifically, examples of materials can include Cu, Ni, Ag, Pd, Au, Pt, or an alloy containing at least one of these metal elements. In a situation where a constituent material of the ceramic layers 10 has resistance to reduction, a main component of the conductive material of the internal electrode layers 12 includes preferably Ni and/or a Ni based alloy. Ni contained in the internal electrode layers 12 and Mn contained in the segregates 14 are alloyed to enable improvement of joint strength at the lamination interface 11. In this context, the “Ni based alloy” is preferably an alloy containing Ni as a main component and Sn (a Ni—Sn based alloy). Also, the “main component of the conductive material of the internal electrode layers 12” means a component, composed of this main component's constituent element or elements, constituting a total of 80 parts by mol or more out of a total of 100 parts by mol of all constituent elements of the conductive material of the internal electrode layers 12. In a situation where Ni or the Ni based alloy is the main component, at least one internal electrode subcomponent selected from Mn, Cu, Cr, and the like may be contained. Moreover, the internal electrode layers 12 may contain a ceramic component of the ceramic layers 10 as an inhibitor (e.g., the CSZT based compound) other than the above conductive material or may contain a slight amount (e.g., about 0.1 mass % or less) of non-metal components, such as S and P. The inhibitor prevents or mitigates sintering of the conductive material during a firing process.

The external electrodes 6 may contain any conductive material. For example, a known conductive material (e.g., Ni, Cu, Sn, Ag, Pd, Pt, Au, their alloys, and a conductive resin) is used. The external electrodes 6 have a thickness appropriately determined according to usage or the like. Normally, the thickness is preferably about 1.0 μm to about 150 μm.

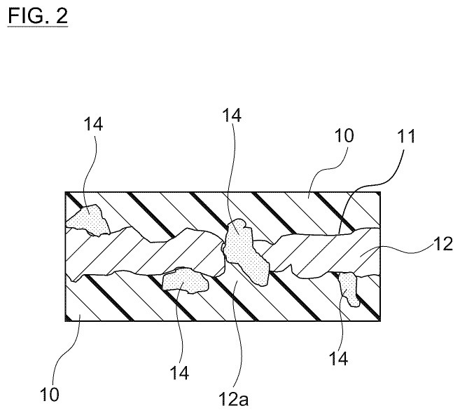

FIG. 2 is a schematic sectional view of the element body 4. In the present embodiment, the element body 4 includes the segregates 14. That is, the segregates 14 are present in the ceramic layers 10 and/or the internal electrode layers 12. The segregates 14 are preferably present at the electrode discontinuous portions 12a. The segregates 14 are preferably in contact with the lamination interfaces 11, which are interfaces between the ceramic layers 10 and the internal electrode layers 12. Moreover, the segregates 14 are preferably present at the electrode discontinuous portions 12a and in contact with the lamination interfaces 11.

The segregates 14 contain Ca and/or Sr, Mn, Si, Ni, and O. The segregates 14 may also contain Al. Hereinafter, Si and/or Al are collectively referred to as “M”. The segregates 14 have high concentrations of Ca and/or Sr, Mn, and M compared to the ceramic layers 10 or the internal electrode layers 12. The segregates 14 also have a high concentration of Ni compared to the ceramic layers 10.

The ratio {(Ca+Sr)/(Zr+Ti)} of the total atomic weight of Ca and Sr to the total atomic weight of Zr and Ti in the segregates 14 is preferably 1.5 to 8.0 or is more preferably 2.5 to 6.5.

Out of a total of 100 parts by mol Hf, Ni, Mn, Ti, Si, Al, Ca, Zr, and Sr in terms of their oxides in the segregates 14, the total of Ca and Sr in terms of their oxides in the segregates 14 accounts for preferably 25 parts by mol or more and less than 60 parts by mol.

In this context, “in terms of a Hf oxide” denotes “in terms of HfO₂”.

“In terms of a Ni oxide” denotes “in terms of NiO”.

“In terms of a Mn oxide” denotes “in terms of MnO”.

“In terms of a Ti oxide” denotes “in terms of TiO₂”.

“In terms of a Si oxide” denotes “in terms of SiO₂”.

“In terms of an Al oxide” denotes “in terms of Al₂O₃”.

“In terms of a Ca oxide” denotes “in terms of CaO”.

“In terms of a Zr oxide” denotes “in terms of ZrO₂”.

“In terms of a Sr oxide” denotes “in terms of SrO”.

The ratio {Mn/(Mn+Si)} of the atomic weight of Mn to the total atomic weight of Mn and Si in the segregates 14 is preferably 0.02 or more and less than 0.50 or is more preferably 0.08 or more and 0.30 or less.

The ratio {Ni/(Ni+Si)} of the atomic weight of Ni to the total atomic weight of Ni and Si in the segregates 14 is preferably 0.02 or more and less than 0.6, or 0.10 or more and 0.40 or less.

The average number of the segregates 14 per unit length of the internal electrode layers 12 is preferably 0.05 per μm or more and less than 0.5 per μm or is more preferably 0.1 per μm or more and 0.3 per μm or less. Note that the length of the internal electrode layers 12 is the length along a direction (X-axis direction or Y-axis direction) perpendicular to the lamination direction (Z-axis direction). Thus, the length of the internal electrode layers 12 is measured in a Y-Z section or a Z-X section of the element body 4; however, in the Y-Z section or the Z-X section of the element body 4, there are the electrode discontinuous portions 12a. In this situation, the electrode discontinuous portions 12a are not included as part of the length of the internal electrode layers 12. The segregates 14 counted in the number of the segregates 14 per unit length of the internal electrode layers 12 are those present at the electrode discontinuous portions 12a of the internal electrode layers 12 and/or those in contact with the lamination interfaces 11 between the ceramic layers 10 and the internal electrode layers 12.

The segregates 14 have an average grain size of preferably 0.1 μm to 15 μm, more preferably 0.5 μm to 10 μm, or still more preferably 1.0 μm to 5 μm. Note that, in the present embodiment, the “average grain size” denotes an arithmetic mean of equivalent circle diameters.

The element body 4 can be analyzed through its sectional observation using, for example, a scanning electron microscope (SEM) or a scanning transmission electron microscope (STEM).

For example, the presence or absence of the segregates 14 can be measured in an image analysis of a sectional photograph obtained in sectional observation using a SEM, a STEM, or the like. In a situation where a section of the element body 4 is observed in its backscattered electron image obtained using a SEM or its HAADF image obtained using a STEM, a highly dense portion is often identifiable as a bright-contrast portion. In the element body 4, the internal electrode layers 12 tend to be the densest; the ceramic layers 10 tend to be the second densest; and the segregates 14 tend to be the least dense. Thus, the internal electrode layers 12 are often identifiable as bright-contrast portions, whereas the segregates 14 are often identifiable as dark-contrast portions. The ceramic layers 10 are often identifiable as portions having contrast darker than that of the internal electrode layers 12 and brighter than that of the segregates 14.

As described above, using lightness contrast found by, for example, binarization of the sectional photograph parallel to the lamination direction of the element body 4, the presence or absence of the segregates 14 in the element body 4, their locations, their sizes, and the number of the segregates 14 can be found.

The grain sizes of the segregates 14 are their equivalent circle diameters. Thus, the areas of the segregates 14 are calculated, and their equivalent circle diameters are calculated; and such equivalent circle diameters can be deemed to be the grain sizes of the segregates 14.

In a section of the element body 4, five fields of view each measuring about 25 μm×about 25 μm are preferably observed to calculate the grain sizes and the number of the segregates 14 to find the average.

The composition of the segregates 14 can be measured through a component analysis using an electron probe microanalyzer (EPMA) in the sectional observation. The component analysis is carried out preferably at least at three locations to calculate the composition of the segregates 14, which is an average of the results of measurement. In the present embodiment, when the EPMA is used for the component analysis or the like, an energy dispersive spectroscope (EDS) or a wavelength dispersive spectroscope (WDS) can be used as an X-ray spectroscope.

An example method of manufacturing the multilayer ceramic capacitor 2 shown in FIGS. 1A and 1B is described next.

First, steps of manufacturing the element body 4 are described. In the steps of manufacturing the element body 4, a dielectric paste to be the ceramic layers 10 after firing and a segregate-including internal electrode paste to be the internal electrode layers 12 after firing are prepared.

The dielectric paste is prepared, for example, as follows. First, dielectric raw materials are uniformly mixed by, for example, wet-mixing and are dried. The resultant mixture is then subject to a heat treatment under predetermined conditions to give a calcined powder. Then, a known organic vehicle or a known water based vehicle is added to the resultant calcined powder, and this mixture is kneaded to prepare the dielectric paste. The dielectric paste obtained in this manner is turned into sheets using, for example, a doctor blade method to give ceramic green sheets. As necessary, the dielectric paste may contain additives selected from various dispersants, plasticizers, dielectrics, subcomponent compounds, glass frit, etc.

The segregate-including internal electrode paste is prepared by kneading a metal material, a known binder, and a known solvent. The metal material is obtained by mixing segregate raw materials containing constituent elements of the segregates 14, calcining this mixture, pulverizing this calcined powder, and mixing this calcined powder with a conductive material. The segregate raw materials include, for example, an oxide, a carbonate, or a hydroxide of the constituent elements of the segregates 14.

Changing the amount of the segregate raw materials in the segregate-including internal electrode paste can change the number of the segregates 14 per unit length of the internal electrode layers 12.

Also, changing pulverization conditions of the calcined powder of the segregate raw materials in the manufacture of the segregate-including internal electrode paste can change the grain sizes of the segregates 14. Specifically, the longer the pulverization time using a ball mill, the smaller the grain sizes of the segregates 14 tend to be.

Then, on the ceramic green sheets, the segregate-including internal electrode paste is applied in a predetermined pattern using a printing method (e.g., screen printing) or a transfer method to form segregate-including internal electrode patterns. Such ceramic green sheets with the segregate-including internal electrode patterns are laminated, and this laminate is pressed in the lamination direction to give a mother laminated body. Note that the ceramic green sheets and the segregate-including internal electrode patterns are laminated so that, at this time, the ceramic green sheets are located at upper and lower surfaces of the mother laminated body in the lamination direction.

The mother laminated body obtained through the above steps is cut into predetermined dimensions by dicing or push-cutting to give green chips. As necessary, the green chips may be subject to solidification drying to remove plasticizers or the like and may then be subject to barrel polishing using a horizontal centrifugal barrel machine or the like. In barrel polishing, the green chips are put into a barrel together with media and a polishing liquid, and a rotational movement or vibration is applied to the barrel. This removes unwanted parts (e.g., burrs generated during cutting). The green chips after barrel polishing are washed with a cleaning solution (e.g., water) and are dried.

Then, each of the resultant green chips is subject to a binder removal treatment and a firing treatment to give the element body 4. Conditions of the binder removal treatment are appropriately determined according to the composition of the main component of the ceramic layers 10 or the composition of the main component of the internal electrode layers 12 and are not limited. For example, the heating rate is preferably 5° C./hour to 300° C./hour; the holding temperature is preferably 180° C. to 400° C.; and the temperature holding time is preferably 0.5 hours to 24 hours. The binder removal atmosphere is air or a reducing atmosphere.

Conditions of the firing treatment are appropriately determined according to the composition of the main component of the ceramic layers 10 or the composition of the main component of the internal electrode layers 12 and are not limited. For example, the holding temperature during firing is preferably 1200° C. to 1400° C. or is more preferably 1220° C. to 1300° C.; the holding time during firing is preferably 0.5 hours to 8 hours or is more preferably 1 hour to 3 hours; and the heating rate and the cooling rate are preferably 50° C./hour to 500° C./hour. The firing atmosphere is preferably a reducing atmosphere. As an ambient gas, for example, a humidified mixed gas of N₂ and H₂ can be used. Further, in a situation where the internal electrode layers 12 are composed of a base material (e.g., Ni or the Ni based alloy), the oxygen partial pressure of the firing atmosphere is preferably 2.0×10⁻¹³ atm to 1.0×10⁻⁷ atm.

After firing, the resultant element body 4 may be subject to a reoxidation treatment (annealing) as necessary. As for annealing conditions, for example, the oxygen partial pressure is preferably higher than that of firing, and the holding temperature is preferably 1150° C. or less.

In the above binder removal treatment, firing treatment, and annealing treatment, for example, a wetter is used to humidify the N₂ gas, the mixed gas, or the like. In this situation, the water temperature is preferably about 5° C. to about 75° C. The binder removal treatment, firing treatment, and annealing treatment may be carried out continuously or independently.

In the firing process of the internal electrode layers 12 of the resultant element body 4, the segregate raw materials are removed outside the internal electrode layers 12 and are deposited as the segregates 14 at the electrode discontinuous portions 12a or at the lamination interfaces 11 on the corresponding ceramic layer 10 side.

End surfaces of the resultant element body 4 are polished, and an external electrode paste is applied there and is baked to form the external electrodes 6. On surfaces of the external electrodes 6, a coating layer is formed by plating or the like as necessary.

The above steps give the multilayer ceramic capacitor 2 including the external electrodes 6.

The resultant multilayer ceramic capacitor 2 can be surface-mounted on a substrate (e.g., a printed wiring board) using solder (including molten solder, solder cream, and a solder paste) or a conductive adhesive and is included in various electronics. Alternatively, the multilayer ceramic capacitor 2 can be mounted on a substrate using a wire-shaped leading terminal or a plate-shaped metal terminal.

The multilayer ceramic capacitor 2 according to the present embodiment can have fewer cracks by including the predetermined segregates 14.

In particular, in a situation where the segregates 14 are those present at the electrode discontinuous portions 12a and/or those in contact with the lamination interfaces 11, the joint strength between the ceramic layers 10 and the internal electrode layers 12 is improved near the electrode discontinuous portions 12a or near the lamination interfaces 11. This can further prevent or reduce cracks starting at the electrode discontinuous portions 12a or the lamination interfaces 11.

In particular, in a situation where the internal electrode layers 12 contain Ni, Mn contained in the segregates 14 and Ni contained in the internal electrode layers 12 are readily alloyed. Thus, the segregates 14 that are formed at the lamination interfaces 11 on the corresponding ceramic layer 10 side and contain Mn and the internal electrode layers 12 containing Ni make Mn and Ni be alloyed to enable an increase in the joint strength. This can prevent or reduce cracks.

Because an electronic device whose ceramic layers 10 are composed of the CSZT based compound has a lower rate of change of permittivity according to temperature than that of an electronic device whose ceramic layers 10 are composed of barium titanate (hereinafter referred to as “BT based compound”), the former electronic device tends to be used at high frequencies.

In this manner, the ceramic layers 10 composed of the CSZT based compound are preferably used at high frequencies. However, because a difference in linear thermal expansion coefficients between the CSZT based compound and Ni is larger than a difference in linear thermal expansion coefficients between the BT based compound and Ni, provided that the main component of the conductive material of the internal electrode layers 12 is Ni and/or the Ni based alloy, cracks are more likely generated when the main component of the ceramic layers 10 is the CSZT based compound than when the main component of the ceramic layers 10 is the BT based compound.

In contrast, in the present embodiment, because the segregates 14 as well contain Ca, Ca contained in the ceramic layers 10 and Ca contained in the segregates 14 undergo mutual diffusion even if the main component of the ceramic layers 10 is the CSZT based compound. Consequently, the segregates 14 can further increase the joint strength between the ceramic layers 10 and the internal electrode layers 12. This can further prevent or reduce cracks.

Further, in a situation where the main component of the ceramic layers 10 is the CSZT based compound, the ceramic layers 10 may contain Mn; and Mn may be contained particularly in the main phase grains composed of the CSZT based compound by being solid-dissolved therein or may be contained in the grain boundary. In the present embodiment, because the segregates 14 as well contain Mn, Mn contained in the main phase grains and/or the grain boundary or the like of the ceramic layers 10 and Mn contained in the segregates 14 undergo mutual diffusion. Consequently, the segregates 14 can further increase the joint strength between the ceramic layers 10 and the internal electrode layers 12. This can further prevent or reduce cracks.

Similarly, in a situation where the main component of the ceramic layers 10 is the CSZT based compound, the ceramic layers 10 may contain M (Si and/or Al). In the present embodiment, because the segregates 14 as well contain M, M contained in the ceramic layers 10 and M contained in the segregates 14 undergo mutual diffusion. Consequently, the joint strength between the ceramic layers 10 and the segregates 14 can further be increased. This can further prevent or reduce cracks.

Although one embodiment of the present invention has been described above, the present invention is not limited to the above embodiment and can be variously modified without departing from the gist of the present invention.

While the multilayer ceramic capacitor 2 exemplifies an electronic device in the present embodiment, an electronic device of the present invention may be a band-pass filter, a multilayer three-terminal filter, a piezoelectric element, a thermistor, a varistor, etc.

While the ceramic layers 10 and the internal electrode layers 12 are laminated in the Z-axis direction in the present embodiment, the lamination direction may be the X-axis direction or the Y-axis direction. In this situation, the external electrodes 6 are formed according to the exposed surfaces of the internal electrode layers 12. Also, the element body 4 is not necessarily a laminated body and may include a single layer. Moreover, the internal electrode layers 12 may be drawn out to an outer surface of the element body 4 via through-hole electrodes. In this situation, the through-hole electrodes and the external electrodes 6 are electrically connected.

### EXAMPLES

Hereinafter, the present invention is described based on more detailed examples; however, the present invention is not limited to these examples.

### Experiment 1

Experiment 1 relates to Sample Nos. 2 to 11, 21 to 22, 41 to 44, 51 to 54, and 61 to 64.

In Experiment 1, multilayer ceramic capacitors 2 were manufactured using the following procedure. First, a dielectric paste and a segregate-including internal electrode paste were prepared. Using these pastes, green chips were manufactured as described in the description of the embodiment using a sheet method.

At this time, as dielectric raw materials contained in the dielectric paste, raw materials having a composition shown in Table 1A, 2A, 4A, 5A, or 6A were used. Note that, as subcomponent compounds contained in the dielectric paste, SiO₂, Al₂O₃, and MnCO₃ were used.

A conductive material of a metal material contained in the segregate-including internal electrode paste was Ni. As for segregate raw materials contained together with Ni in the metal material, each element content was controlled so that the composition of segregates was as shown in Table 1B, 2B, 4B, 5B, or 6B after firing.

Then, the resultant green chips were subject to a binder removal treatment under conditions described in the description of the embodiment. Then, a firing treatment was carried out to give element bodies 4. As for conditions of the firing treatment, the holding temperature was 1300° C.; the holding time was 2 hours; and the ambient gas was a humidified mixed gas of N₂ and H₂. Then, the element bodies 4 were subject to an annealing treatment under conditions described in the description of the embodiment.

End surfaces of the element bodies 4 obtained as above were polished, and an external electrode paste was applied there and was baked to form external electrodes 6.

In Experiment 1, the respective element bodies 4 of the capacitor samples had a dimension of L0×W0×T0=2.0 mm×1.30 mm×1.30 mm. The number of ceramic layers 10 interposed between internal electrode layers 12 was 80.

From the capacitor samples according to Sample No. 9 of Experiment 1, samples for destructive inspection were extracted; and these samples were subject to sectional observation using a SEM. Specifically, the extracted samples were cut along a Z-X plane, and the resultant sections were mirror polished. Then, using their SEM secondary electron images, the average thickness Td of the ceramic layers 10 and the average thickness Te of the internal electrode layers 12 were measured. The results of measurement were as follows.
Average thickness Td of the ceramic layers 10: 2.50 μm
Average thickness Te of the internal electrode layers 12: 1.10 μm

In the above sectional observation, the presence or absence of the segregates 14 was checked; and components of the ceramic layers 10, the internal electrode layers 12, and the segregates 14 were analyzed using an EPMA through point analyses. Consequently, it was confirmed that the results of measurement of the composition of the ceramic layers 10 approximately corresponded to the results of measurement of the compositions of the dielectric raw materials and the subcomponent compounds contained in the dielectric paste. It was also confirmed that the internal electrode layers 12 contained, as a main component, Ni (conductive material) contained in an internal electrode paste. It was further confirmed that the results of measurement of the composition of the segregates 14 approximately corresponded to the results of measurement of the composition of the segregate raw materials contained in the segregate-including internal electrode paste.

Thus, it was presumed that, in each experiment described below, the results of measurement of the composition of the ceramic layers 10 corresponded to the results of measurement of the compositions of the dielectric raw materials and the subcomponent compounds contained in the dielectric paste. It was also presumed that the internal electrode layers 12 contained, as a main component, Ni (conductive material) contained in the internal electrode paste or the segregate-including internal electrode paste. It was further presumed that the results of measurement of the composition of the segregates 14 corresponded to the results of measurement of the composition of the segregate raw materials contained in the segregate-including internal electrode paste.

Tables 1B, 2B, 4B, 5B, 6B, 7B, and 8B show the presence or absence of the segregates 14.

Tables 1C, 2C, 4C, 5C, 6C, 7C, and 8C show locations of the segregates 14.

In Tables 4B, 5B, 6B, 7B, and 8B, the ratio of the total atomic weight of Ca and Sr to the total atomic weight of Zr and Ti in the segregates 14 of each sample is shown in the “(Ca+Sr)/(Zr+Ti)” column.

In Tables 5B, 6B, 7B, and 8B, the ratio of the atomic weight of Mn to the total atomic weight of Mn and Si in the segregates 14 of each sample is shown in the “Mn/(Mn+Si)” column.

In Tables 6B, 7B, and 8B, the ratio of the atomic weight of Ni to the total atomic weight of Ni and Si in the segregates 14 of each sample is shown in the “Ni/(Ni+Si)” column.

In Tables 7B and 8B, the average number of the segregates 14 per unit length of the internal electrode layers 12 is shown in the “Number per unit length [per μm]” column.

In Table 8B, the average grain size of the segregates 14 is shown in the “Grain size [μm]” column.

In Experiment 1, to evaluate the crack occurrence rate of the manufactured capacitor samples in a high-temperature and high-humidity environment, the crack occurrence rate of the samples after a 24-hour pressure cooker test (PCT) and/or a 168-hour PCT was calculated. The details are provided below.

<Crack Occurrence Rate after 24-Hour PCT>

The capacitor samples were mounted on a FR4 substrate (glass epoxy substrate) using Sn—Ag—Cu solder and were introduced in a pressure cooker tank to conduct an accelerated moisture resistance load test at 121° C. and a humidity of 95% for 24 hours. One hundred capacitor samples were subject to the test. Tables 1C, 2C, 4C, 5C, and 6C show the number of capacitor samples with cracks. In the present examples, the crack occurrence rate after the 24-hour PCT was preferably 10% or less or was more preferably 3% or less.

<Crack Occurrence Rate after 168-Hour PCT>

The capacitor samples were mounted on a FR4 substrate (glass epoxy substrate) using Sn—Ag—Cu solder and were introduced in a pressure cooker tank to conduct an accelerated moisture resistance load test at 121° C. and a humidity of 95% for 168 hours. One hundred capacitor samples were subject to the test. Tables 1C and 2C show the number of capacitor samples with cracks. In the present examples, the crack occurrence rate after the 168-hour PCT was preferably 20% or less or was more preferably 6% or less.

### Experiment 2

Experiment 2 relates to Sample No. 1. In Experiment 2, capacitor samples were manufactured as in Experiment 1 except that, instead of the segregate-including internal electrode paste, the internal electrode paste was used. The crack occurrence rate of the samples after the 24-hour PCT and the 168-hour PCT was calculated. Table 1C shows the results.

Note that, except that the internal electrode paste did not contain the calcined powder of the segregate raw materials, the internal electrode paste was similar to the segregate-including internal electrode paste.

### Experiment 3

Experiment 3 relates to Sample No. 31. In Experiment 3, other than the dielectric paste, a segregate-including dielectric paste was prepared. The segregate-including dielectric paste was similar to the dielectric paste except for containing the calcined powder of the segregate raw materials.

In Experiment 3, ceramic green sheets had the following three-layer structure. First, using the dielectric paste, a ceramic green sheet was formed. Then, on this ceramic green sheet, a segregate-including ceramic green sheet was formed using the segregate-including dielectric paste. Further, on this segregate-including ceramic green sheet, another ceramic green sheet was formed using the dielectric paste. This provided the three-layered ceramic green sheets.

In Experiment 3, the segregate-including internal electrode paste was not used, and the internal electrode paste of Experiment 2 was used.

That is, the three-layered ceramic green sheets having internal electrode patterns formed using the internal electrode paste (internal electrode pattern-ceramic green sheet-segregate-including ceramic green sheet-ceramic green sheet) were laminated.

Capacitor samples were manufactured as in Experiment 1 except for the above, and the crack occurrence rate of the samples after the 24-hour PCT and the 168-hour PCT was calculated. Table 3C shows the results.

### Experiment 4

Experiment 4 relates to Sample No. 32. In Experiment 4, an internal electrode pattern had the following three-layer structure. First, on a ceramic green sheet, an internal electrode pattern was formed using the internal electrode paste. Then, on this internal electrode pattern, a segregate-including internal electrode pattern was formed using the segregate-including internal electrode paste. Further, on this segregate-including internal electrode pattern, another internal electrode pattern was formed using the internal electrode paste. This provided the three-layered internal electrode pattern.

Then, ceramic green sheets with the three-layered internal electrode pattern (internal electrode pattern-segregate-including internal electrode pattern-internal electrode pattern-ceramic green sheet) were laminated.

Capacitor samples were manufactured as in Experiment 1 except for the above, and the crack occurrence rate of the samples after the 24-hour PCT and the 168-hour PCT was calculated. Table 3C shows the results.

### Experiment 7

Experiment 7 relates to Sample Nos. 71 to 74. In Experiment 7, capacitor samples were manufactured as in Experiment 1 except that the amount of the calcined powder of the segregate raw materials contained in the internal electrode paste was changed to change the number of the segregates per unit length of the internal electrode layers. The crack occurrence rate of the samples after the 24-hour PCT was calculated. Table 7C shows the results.

### Experiment 8

Experiment 8 relates to Sample Nos. 81 to 84. In Experiment 8, capacitor samples were manufactured as in Experiment 1 except that conditions of pulverization of the calcined powder of the segregate raw materials contained in the internal electrode paste were changed to change the grain sizes of the segregates 14. The crack occurrence rate of the samples after the 24-hour PCT was calculated. Table 8C shows the results.

TABLE 1A

| | | | Internal |
|---|---|---|---|
| | | Dielectric layer | electrode layer |
| Sample | Manufacturing | Composition of main | Main |
| No. | method | component | component |
| 1 | Experiment 2 | (Ca_{0.7}Sr_{0.3})(Zr_{0.97}Ti_{0.03})O₃ | Ni |
| 2 | Experiment 1 | (Ca_{0.7}Sr_{0.3})(Zr_{0.97}Ti_{0.03})O₃ | Ni |
| 3 | Experiment 1 | (Ca_{0.7}Sr_{0.3})(Zr_{0.97}Ti_{0.03})O₃ | Ni |
| 4 | Experiment 1 | (Ca_{0.7}Sr_{0.3})(Zr_{0.97}Ti_{0.03})O₃ | Ni |
| 5 | Experiment 1 | (Ca_{0.7}Sr_{0.3})(Zr_{0.97}Ti_{0.03})O₃ | Ni |
| 6 | Experiment 1 | (Ca_{0.7}Sr_{0.3})(Zr_{0.97}Ti_{0.03})O₃ | Ni |
| 7 | Experiment 1 | (Ca_{0.7}Sr_{0.3})(Zr_{0.97}Ti_{0.03})O₃ | Ni |
| 8 | Experiment 1 | (Ca_{0.7}Sr_{0.3})(Zr_{0.97}Ti_{0.03})O₃ | Ni |
| 9 | Experiment 1 | (Ca_{0.7}Sr_{0.3})(Zr_{0.97}Ti_{0.03})O₃ | Ni |
| 10 | Experiment 1 | CaZrO₃ | Ni |
| 11 | Experiment 1 | BaTiO₃ | Ni |

TABLE 1B

Segregate

| | Present | |
|---|---|---|
| Sample | or | |
| No. | absent | Composition |
| 1 | Absent | |
| 2 | Present | Si-O |
| 3 | Present | Ca-Si-O |
| 4 | Present | Al-Si-O |
| 5 | Present | Mn-O |
| 6 | Present | Mn-Y-O |
| 7 | Present | M g-Si-O |
| 8 | Present | (Ca,Sr)- |
| | | Mg-Ni-M-O |
| 9 | Present | (Ca,Sr)- |
| | | Mn-Ni-M-O |
| 10 | Present | (Ca,Sr)- |
| | | Mn-Ni-M-O |
| 11 | Present | (Ca,Sr)- |
| | | Mn-Ni-M-O |

TABLE 1C

| | Segregate | | | |
|---|---|---|---|---|
| | Element body | | | |
| | includes segregate | | | |
| | present at | | | |
| | electrode | | | |
| | discontinuous | | | |
| | portion of | | | |
| | internal electrode | | | |
| | layer and/or | | | |
| | segregate in | | | |
| | contact with | | | |
| | lamination | | | |
| | interface | | | |
| | between dielectric | | Crack occurrence rate | |
| | layer and | | After | After |
| Sample | internal | | 24-hour | 168-hour |
| No. | electrode layer | Remarks | PCT | PCT |
| 1 | No | Element body does | 20/100 | 53/100 |
| | | not include | | |
| | | segregate present | | |
| | | at electrode | | |
| | | discontinuous | | |
| | | portion of internal | | |
| | | electrode layer or | | |
| | | segregate in contact | | |
| | | with lamination | | |
| | | interface | | |
| | | between dielectric | | |
| | | layer and | | |
| | | internal electrode | | |
| | | layer | | |
| 2 | Yes | | 17/100 | 50/100 |
| 3 | Yes | | 14/100 | 45/100 |
| 4 | Yes | | 12/100 | 31/100 |
| 5 | Yes | | 15/100 | 35/100 |
| 6 | Yes | | 20/100 | 33/100 |
| 7 | Yes | | 18/100 | 31/100 |
| 8 | Yes | | 22/100 | 36/100 |
| 9 | Yes | | 0/100 | 0/100 |
| 10 | Yes | | 0/100 | 0/100 |
| 11 | Yes | | 16/100 | 37/100 |

TABLE 2A

| | | | Internal |
|---|---|---|---|
| | | Dielectric layer | electrode layer |
| Sample | Manufacturing | Composition of main | Main |
| No. | method | component | component |
| 21 | Experiment 1 | (Ca_{0.7}Sr_{0.3})(Zr_{0.75}Ti_{0.25})O₃ | Ni |
| 22 | Experiment 1 | (Ca_{0.7}Sr_{0.3})(Zr_{0.75}Ti_{0.25})O₃ | Ni |
| 9 | Experiment 1 | (Ca_{0.7}Sr_{0.3})(Zr_{0.75}Ti_{0.25})O₃ | Ni |

TABLE 2B

Segregate

| | Present | |
|---|---|---|
| Sample | or | |
| No. | absent | Composition |
| 21 | Present | (Ca,Sr)- |
| | | Mn-Ni-M-O |
| 22 | Present | (Ca,Sr)- |
| | | Mn-Ni-M-O |
| 9 | Present | (Ca,Sr)- |
| | | Mn-Ni-M-O |

TABLE 2C

| | Segregate | | |
|---|---|---|---|
| | Element body includes segregate | | |
| | present at electrode | | |
| | discontinuous portion of | Crack | |
| | internal electrode layer and/or | occurrence | |
| | segregate in contact with | rate | |
| | lamination interface between | After | After |
| Sample | dielectric layer and internal | 24-hour | 168-hour |
| No. | electrode layer | PCT | PCT |
| 21 | Yes | 18/100 | 43/100 |
| 22 | Yes | 0/100 | 0/100 |
| 9 | Yes | 0/100 | 0/100 |

TABLE 3A

| | | | Internal |
|---|---|---|---|
| | | Dielectric layer | electrode layer |
| Sample | Manufacturing | Composition of main | Main |
| No. | method | component | component |
| 31 | Experiment 3 | (Ca_{0.7}Sr_{0.3})(Zr_{0.97}Ti_{0.03})O₃ | Ni |
| 32 | Experiment 4 | (Ca_{0.7}Sr_{0.3})(Zr_{0.97}Ti_{0.03})O₃ | Ni |
| 9 | Experiment 1 | (Ca_{0.7}Sr_{0.3})(Zr_{0.97}Ti_{0.03})O₃ | Ni |

TABLE 3B

Segregate

| | Present | |
|---|---|---|
| Sample | or | |
| No. | absent | Composition |
| 31 | Present | (Ca,Sr)- |
| | | Mn-Ni-M-O |
| 32 | Present | (Ca,Sr)- |
| | | Mn-Ni-M-O |
| 9 | Present | (Ca,Sr)- |
| | | Mn-Ni-M-O |

TABLE 3C

| | Segregate | | | |
|---|---|---|---|---|
| | Element body | | | |
| | includes segregate | | | |
| | present at electrode | | | |
| | discontinuous portion | | | |
| | of internal | | | |
| | electrode layer | | | |
| | and/or segregate | | | |
| | in contact with | | | |
| | lamination interface | | Crack occurrence rate | |
| | between dielectric | | After | After |
| Sample | layer and internal | | 24-hour | 168-hour |
| No. | electrode layer | Remarks | PCT | PCT |
| 31 | No | Segregate is | 4/100 | 13/100 |
| | | present only | | |
| | | in dielectric | | |
| | | layer but is | | |
| | | not present | | |
| | | at lamination | | |
| | | interface | | |
| | | or electrode | | |
| | | discontinuous | | |
| | | portion | | |
| 32 | No | Segregate is | 5/100 | 15/100 |
| | | present in | | |
| | | internal | | |
| | | electrode | | |
| | | layer but | | |
| | | is not present | | |
| | | at lamination | | |
| | | interface | | |
| | | or electrode | | |
| | | discontinuous | | |
| | | portion | | |
| 9 | Yes | Segregate is | 0/100 | 0/100 |
| | | present at | | |
| | | lamination | | |
| | | interface and | | |
| | | electrode | | |
| | | discontinuous | | |
| | | portion | | |

TABLE 4A

| | | | Internal |
|---|---|---|---|
| | | Dielectric layer | electrode layer |
| Sample | Manufacturing | Composition of main | Main |
| No. | method | component | component |
| 41 | Experiment 1 | (Ca_{0.7}Sr_{0.3})(Zr_{0.97}Ti_{0.03})O₃ | Ni |
| 42 | Experiment 1 | (Ca_{0.7}ST_{0.3})(Zr_{0.97}Ti_{0.03})O₃ | Ni |
| 9 | Experiment 1 | (Ca_{0.7}Sr_{0.3})(Zr_{0.97}Ti_{0.03})O₃ | Ni |
| 43 | Experiment 1 | (Ca_{0.7}Sr_{0.3})(Zr_{0.97}Ti_{0.03})O₃ | Ni |
| 44 | Experiment 1 | (Ca_{0.7}Sr_{0.3})(Zr_{0.97}Ti_{0.03})O₃ | Ni |

TABLE 4B

Segregate

| | Present | | |
|---|---|---|---|
| Sample | or | | (Ca + Sr)/ |
| No. | absent | Composition | (Zr + Ti) |
| 41 | Present | (Ca,Sr)- | 0.10 |
| | | Mn-Ni-M-O | |
| 42 | Present | (Ca,Sr)- | 1.55 |
| | | Mn-Ni-M-O | |
| 9 | Present | (Ca,Sr)- | 3.38 |
| | | Mn-Ni-M-O | |
| 43 | Present | (Ca,Sr)- | 7.88 |
| | | Mn-Ni-M-O | |
| 44 | Present | (Ca,Sr)- | 10.74 |
| | | Mn-Ni-M-O | |

TABLE 4C

| | Segregate | |
|---|---|---|
| | Element body includes segregate | |
| | present at electrode discontinuous | |
| | portion of internal electrode layer | |
| | and/or segregate in contact with | |
| | lamination interface between | |
| Sample | dielectric layer and internal | Crack occurrence rate |
| No. | electrode layer | After 24-hour PCT |
| 41 | Yes | 8/100 |
| 42 | Yes | 0/100 |
| 9 | Yes | 0/100 |
| 43 | Yes | 0/100 |
| 44 | Yes | 9/100 |

TABLE 5A

| | | | Internal |
|---|---|---|---|
| | | Dielectric layer | electrode layer |
| Sample | Manufacturing | Composition of main | Main |
| No. | method | component | component |
| 51 | Experiment 1 | (Ca_{0.7}Sr_{0.3})(Zr_{0.97}Ti_{0.03})O₃ | Ni |
| 52 | Experiment 1 | (Ca_{0.7}ST_{0.3})(Zr_{0.97}Ti_{0.03})O₃ | Ni |
| 9 | Experiment 1 | (Ca_{0.7}Sr_{0.3})(Zr_{0.97}Ti_{0.03})O₃ | Ni |
| 53 | Experiment 1 | (Ca_{0.7}ST_{0.3})(Zr_{0.97}Ti_{0.03})O₃ | Ni |
| 54 | Experiment 1 | (Ca_{0.7}Sr_{0.3})(Zr_{0.97}Ti_{0.03})O₃ | Ni |

TABLE 5B

Segregate

| | Present | | | |
|---|---|---|---|---|
| Sample | or | | (Ca + Sr)/ | Mn/ |
| No. | absent | Composition | (Zr + Ti) | (Mn + Si) |
| 51 | Present | (Ca,Sr)- | 3.86 | 0.01 |
| | | Mn-Ni-M-O | | |
| 52 | Present | (Ca,Sr)- | 3.98 | 0.02 |
| | | Mn-Ni-M-O | | |
| 9 | Present | (Ca,Sr)- | 3.85 | 0.15 |
| | | Mn-Ni-M-O | | |
| 53 | Present | (Ca,Sr)- | 3.88 | 0.48 |
| | | Mn-Ni-M-O | | |
| 54 | Present | (Ca,Sr)- | 3.46 | 1.1 |
| | | Mn-Ni-M-O | | |

TABLE 5C

| | Segregate | |
|---|---|---|
| | Element body includes segregate | |
| | present at electrode discontinuous | |
| | portion of internal electrode layer | |
| | and/or segregate in contact with | |
| | lamination interface between | |
| Sample | dielectric layer and internal | Crack occurrence rate |
| No. | electrode layer | After 24-hour PCT |
| 51 | Yes | 3/100 |
| 52 | Yes | 0/100 |
| 9 | Yes | 0/100 |
| 53 | Yes | 0/100 |
| 54 | Yes | 7/100 |

TABLE 6A

| | | | Internal |
|---|---|---|---|
| | | Dielectric layer | electrode layer |
| Sample | Manufacturing | Composition of main | Main |
| No. | method | component | component |
| 61 | Experiment 1 | (Ca_{0.7}Sr_{0.3})(Zr_{0.97}Ti_{0.03})O₃ | Ni |
| 62 | Experiment 1 | (Ca_{0.7}Sr_{0.3})(Zr_{0.97}Ti_{0.03})O₃ | Ni |
| 9 | Experiment 1 | (Ca_{0.7}Sr_{0.3})(Zr_{0.97}Ti_{0.03})O₃ | Ni |
| 63 | Experiment 1 | (Ca_{0.7}Sr_{0.3})(Zr_{0.97}Ti_{0.03})O₃ | Ni |
| 64 | Experiment 1 | (Ca_{0.7}Sr_{0.3})(Zr_{0.97}Ti_{0.03})O₃ | Ni |

TABLE 6B

| | Segregate | | | | |
|---|---|---|---|---|---|
| | Present | | | | |
| Sample | or | | (Ca + Sr)/ | M n/ | Ni/ |
| No. | absent | Composition | (Zr + Ti) | (Mn + Si) | (Ni + Si) |
| 61 | Present | (Ca,Sr)- | 4.06 | 0.17 | 0.01 |
| | | Mn-Ni-M-O | | | |
| 62 | Present | (Ca,Sr)- | 3.49 | 0.14 | 0.02 |
| | | Mn-Ni-M-O | | | |
| 9 | Present | (Ca,Sr)- | 3.71 | 0.11 | 0.24 |
| | | Mn-Ni-M-O | | | |
| 63 | Present | (Ca,Sr)- | 3.92 | 0.15 | 0.59 |
| | | Mn-Ni-M-O | | | |
| 64 | Present | (Ca,Sr)- | 3.47 | 0.13 | 1.6 |
| | | Mn-Ni-M-O | | | |

TABLE 6C

| | Segregate | |
|---|---|---|
| | Element body includes segregate | |
| | present at electrode discontinuous | |
| | portion of internal electrode layer | |
| | and/or segregate in contact with | |
| | lamination interface between | |
| Sample | dielectric layer and internal | Crack occurrence rate |
| No. | electrode layer | After 24-hour PCT |
| 61 | Yes | 3/100 |
| 62 | Yes | 0/100 |
| 9 | Yes | 0/100 |
| 63 | Yes | 0/100 |
| 64 | Yes | 7/100 |

TABLE 7A

| | | | Internal |
|---|---|---|---|
| | | Dielectric layer | electrode layer |
| Sample | Manufacturing | Composition of main | Main |
| No. | method | component | component |
| 71 | Experiment 7 | (Ca_{0.7}Sr_{0.3})(Zr_{0.97}Ti_{0.03})O₃ | Ni |
| 72 | Experiment 7 | (Ca_{0.7}Sr_{0.3})(Zr_{0.97}Ti_{0.03})O₃ | Ni |
| 9 | Experiment 1 | (Ca_{0.7}Sr_{0.3})(Zr_{0.97}Ti_{0.03})O₃ | Ni |
| 73 | Experiment 7 | (Ca_{0.7}Sr_{0.3})(Zr_{0.97}Ti_{0.03})O₃ | Ni |
| 74 | Experiment 7 | (Ca_{0.7}Sr_{0.3})(Zr_{0.97}Ti_{0.03})O₃ | Ni |

TABLE 7B

| | Segregate | | | | | |
|---|---|---|---|---|---|---|
| | Present | | | | | Number per |
| Sample | or | | (Ca + Sr)/ | Mn/ | Ni/ | unit length |
| No. | absent | Composition | (Zr + Ti) | (Mn + Si) | (Ni + Si) | [per μm] |
| 71 | Present | (Ca,Sr)- | 3.94 | 0.2 | 0.17 | 0.01 |
| | | Mn-Ni-M-O | | | | |
| 72 | Present | (Ca,Sr)- | 3.88 | 0.16 | 0.15 | 0.02 |
| | | Mn-Ni-M-O | | | | |
| 9 | Present | (Ca,Sr)- | 3.72 | 0.16 | 0.18 | 0.26 |
| | | Mn-Ni-M-O | | | | |
| 73 | Present | (Ca,Sr)- | 3.41 | 0.18 | 0.24 | 0.42 |
| | | Mn-Ni-M-O | | | | |
| 74 | Present | (Ca,Sr)- | 3.78 | 0.13 | 0.25 | 0.86 |
| | | Mn-Ni-M-O | | | | |

TABLE 7C

| | Segregate | |
|---|---|---|
| | Element body includes segregate | |
| | present at electrode discontinuous | |
| | portion of internal electrode layer | |
| | and/or segregate in contact with | |
| | lamination interface between | |
| Sample | dielectric layer and internal | Crack occurrence rate |
| No. | electrode layer | After 24-hour PCT |
| 71 | Yes | 4/100 |
| 72 | Yes | 0/100 |
| 9 | Yes | 0/100 |
| 73 | Yes | 0/100 |
| 74 | Yes | 6/100 |

TABLE 8A

| | | | Internal |
|---|---|---|---|
| | | Dielectric layer | electrode layer |
| Sample | Manufacturing | Composition of main | Main |
| No. | method | component | component |
| 81 | Experiment 8 | (Ca_{0.7}Sr_{0.3})(Zr_{0.97}Ti_{0.03})O₃ | Ni |
| 82 | Experiment 8 | (Ca_{0.7}Sr_{0.3})(Zr_{0.97}Ti_{0.03})O₃ | Ni |
| 9 | Experiment 1 | (Ca_{0.7}Sr_{0.3})(Zr_{0.97}Ti_{0.03})O₃ | Ni |
| 83 | Experiment 8 | (Ca_{0.7}Sr_{0.3})(Zr_{0.97}Ti_{0.03})O₃ | Ni |
| 84 | Experiment 8 | (Ca_{0.7}Sr_{0.3})(Zr_{0.97}Ti_{0.03})O₃ | Ni |

TABLE 8B

| | Segregate | | | | | | |
|---|---|---|---|---|---|---|---|
| | Present | | | | | Number per | Grain |
| Sample | or | | (Ca+Sr)/ | Mn/ | Ni/ | unit length | size |
| No. | absent | Composition | (Zr + Ti) | (Mn + Si) | (Ni + Si) | [per μm] | [μm] |
| 81 | Present | (Ca,Sr)- | 4.02 | 0.20 | 0.24 | 0.31 | 0.01 |
| | | Mn-Ni-M-O | | | | | |
| 82 | Present | (Ca,Sr)- | 3.39 | 0.16 | 0.23 | 0.29 | 0.13 |
| | | Mn-Ni-M-O | | | | | |
| 9 | Present | (Ca,Sr)- | 3.31 | 0.18 | 0.15 | 0.34 | 1.4 |
| | | Mn-Ni-M-O | | | | | |
| 83 | Present | (Ca,Sr)- | 3.11 | 0.17 | 0.23 | 0.36 | 12 |
| | | Mn-Ni-M-O | | | | | |
| 84 | Present | (Ca,Sr)- | 3.76 | 0.11 | 0.16 | 0.24 | 24 |
| | | Mn-Ni-M-O | | | | | |

TABLE 8C

| | Segregate | |
|---|---|---|
| | Element body includes segregate | |
| | present at electrode discontinuous | |
| | portion of internal electrode layer | |
| | and/or segregate in contact with | |
| | lamination interface between | |
| Sample | dielectric layer and internal | Crack occurrence rate |
| No. | electrode layer | After 24-hour PCT |
| 81 | Yes | 10/100 |
| 82 | Yes | 0/100 |
| 9 | Yes | 0/100 |
| 83 | Yes | 0/100 |
| 84 | Yes | 7/100 |

In a situation where the element bodies did not include the segregates containing Ca and/or Sr, Mn, Si, Ni, and O (Sample Nos. 1 to 8), the crack occurrence rate of the samples after the 24-hour PCT was 12% or more, and the crack occurrence rate of the samples after the 168-hour PCT was 31% or more.

In a situation where the main component of the dielectric layers was not a compound representable by (Ca₁₋ₓSrₓ)ₘ(Zr_{1-y-z}Ti_{y}Hf_{z})O₃ (Sample No. 11), the crack occurrence rate of the samples after the 24-hour PCT was 16%, and the crack occurrence rate of the samples after the 168-hour PCT was 37%.

In a situation where the main component of the dielectric layers was a compound representable by (Ca₁₋ₓSrₓ)ₘ(Zr_{1-y-z}Ti_{y}Hf_{z})O₃ but y and z did not satisfy 0.80≤1-y-z≤1.0 (Sample No. 21), the crack occurrence rate of the samples after the 24-hour PCT was 18%, and the crack occurrence rate of the samples after the 168-hour PCT was 43%.

In contrast, in a situation where the main component of the dielectric layers was a compound representable by the composition formula (Ca₁₋ₓSrₓ)ₘ(Zr_{1-y-z}Ti_{y}Hf_{z})O₃, m ranged from 0.9 to 1.1, x satisfied 0≤x≤1, y and z satisfied 0.80≤1-y-z≤1.0, and the element bodies included the segregates containing Ca and/or Sr, Mn, Si, Ni, and O (Sample No. 9), the crack occurrence rate of the samples after the 24-hour PCT was 0%, and the crack occurrence rate of the samples after the 168-hour PCT was 0%.

Therefore, an effect of preventing or reducing cracks in a high-temperature and high-humidity environment was confirmed when the main component of the dielectric layers was a compound representable by the composition formula (Ca₁₋ₓSrₓ)ₘ(Zr_{1-y-z}Ti_{y}Hf_{z})O₃, m ranged from 0.9 to 1.1, x satisfied 0≤x≤1, y and z satisfied 0.80≤1-y-z≤1.0, and the element bodies included the segregates containing Ca and/or Sr. Mn. Si. Ni, and O.

### REFERENCE NUMERALS

2 . . . multilayer ceramic capacitor
4 . . . element body
10 . . . ceramic layer (dielectric layer)
11 . . . lamination interface
12 . . . internal electrode layer
12a . . . electrode discontinuous portion
14 . . . segregate
6 . . . external electrode

What is claimed is:

1. An electronic device comprising:
an element body comprising a ceramic layer and an internal electrode layer being laminated,
wherein
the ceramic layer comprises a perovskite-type compound having a main component represented by a formula ABO₃;
the perovskite-type compound comprises a compound representable by a composition formula (Ca₁₋ₓSrₓ)ₘ(Zr_{1-y-z}Ti_{y}Hf_{z})O₃, where
m ranges from 0.9 to 1.1,
$$\begin{matrix}x statisfies 0 \leq x \leq 1 , and \\ y and z satisfy 0.8 \leq 1 - y - z \leq 1. ;\end{matrix}$$
the element body comprises segregates; and
the segregates comprise Ca and/or Sr, Mn, Si, Ni, and O.

2. The electronic device according to claim 1, wherein the segregates comprise Al.

3. The electronic device according to claim 1, wherein the segregates included in the element body comprise a segregate present at an electrode discontinuous portion of the internal electrode layer and/or a segregate in contact with a lamination interface between the ceramic layer and the internal electrode layer.

4. The electronic device according to claim 1, wherein a ratio {(Ca+Sr)/(Zr+Ti)} of a total atomic weight of Ca and Sr to a total atomic weight of Zr and Ti in the segregates is 1.5 to 8.0.

5. The electronic device according to claim 1, wherein a ratio {Mn/(Mn+Si)} of an atomic weight of Mn to a total atomic weight of Mn and Si in the segregates is 0.02 or more and less than 0.50.

6. The electronic device according to claim 1, wherein a ratio {Ni/(Ni+Si)} of an atomic weight of Ni to a total atomic weight of Ni and Si in the segregates is 0.02 or more and less than 0.6.

7. The electronic device according to claim 3, wherein an average number of the segregates per unit length of the internal electrode layer is 0.05 per μm or more and less than 0.5 per μm.

8. The electronic device according to claim 1, wherein the segregates have an average grain size of 0.1 μm to 15 μm.

9. The electronic device according to claim 1, wherein a main component of a conductive material included in the internal electrode layer comprises Ni and/or a Ni based alloy.
